(19) United States
(12) Patent Application Publication
(10) Pub. No.: US 2011/0197120 A1
(43) Pub. Date: Aug. 11, 2011

(54) Document Flagging And Indexing System

(76) Inventors: Kevin M. Arst, San Francisco, CA (US); Peter G. Mikhail, San Francisco, CA (US)

(21) Appl. No.: 13/087,720

(22) Filed: Apr. 15, 2011

Related U.S. Application Data
(62) Division of application No. 11/561,353, filed on Nov. 17, 2006.
(60) Provisional application No. 60/782,251, filed on Mar. 13, 2006.

(51) Int. Cl. G06F 17/20

(52) U.S. Cl. 715/230

(57) ABSTRACT

An improved document flag and series of flags is useful in highlighting information within documents. Indicia on the flags can be used to indicate and quickly access different topics and sub topics within a document. In certain embodiments the flags include a perforation that facilitates easy removal and a copier invisible correlating indicator that facilitates replacement of the flag in its original location after a copy of the document is made. In another embodiment an electronic flagging system facilitates electronic document review and organization.

### CROSS REFERENCE TO RELATED APPLICATIONS

This application is a division of U.S. patent application Ser. No. 11/561,353, filed on Nov. 17, 2006, which claims the benefit of U.S. provisional patent application No. 60/782,251, filed on Mar. 13, 2006, all incorporate herein by reference.

### FIELD OF THE INVENTION

The present application is generally related to document management, and more specifically to a system using flags or markers to denote noteworthy portions within documents.

### BACKGROUND OF THE INVENTION

Document flags have traditionally been used to denote relevant sections of a page or document. The Post-it® document flag by the Minnesota Mining and Manufacturing Company (“3M”) is one example of a commercially successful document flag. It comes in a variety of colors and styles. Post-it® style document flags are used to organize and emphasize information quickly and easily. They are often used to draw attention to critical items, for indexing and filing, or for color coding.

Post-it® Style document flags, such as those marketed by 3M, are described in U.S. Pat. Nos. 5,283,091 and 4,770,320. These patents, and all patents and other documents referenced anywhere herein, are incorporated by reference in their entireties.

3M currently markets a myriad of Post-it® Style Document Flags on its website. The standard and small flags have a transparent portion that has an adhesive on the underside. The transparent portion is intended to be affixed to the document and the colored portion will extend away from the edge of the document and serves to help one locate or “flag” important information on and within the flagged page. When a document is copied, the transparent portion will not affect the copy and the underlying content will be reproduced. The colored portion of the standard and small flags does not include any text or other marking. The flags are sold in dispensers by their color. For example, one can buy a dispenser of tabs of a certain color such as Red, Blue, Green, Orange, Yellow, White, Bright Purple, Bright Pink, Bright Green, and Bright Blue colors.

3M also markets a variety of flags where the colored portion extends over the adhesive and therefore over the surface of the document once the flag is affixed to the document. These include the Printed Message Flags that are used to indicate actions required on a document. The flag with its printed message is typically used to: request signatures, initials, and notary needs; or indicate notes, copies and areas of high importance. 3M's Attention Set Flags are available in “Rush!,” “Note,” “Copy,” and “Important.” The Signature Set Flags are available in “Initial,” “Sign & Date,” “Sign Here,” and “Sign & Return.” Single-Pack Flags are available in “Sign Here,” “Note,” “Initial Here,” “Sign & Date,” and Notarize.” Post-it® Arrow Flags include a colored arrow that spans the entire length of the flag, including both the portion affixed to the document and the free portion. The arrow flags are also available in a variety of colors. Message Arrow Flags are the same as arrow flags but also include text on the arrow such as “Sign Here.”

As mentioned previously, these flags can be used to highlight relevant information. Other systems of referencing and highlighting relevant information have also been previously developed.

One such system for learning a foreign language is taught by U.S. Pat. No. 6,325,630. In order to learn the language, a label with the word for an object, in the language to be learned, is made to be placed on an object. The labels can also be placed on a label carrier or other documents with items represented thereon. Another type of publication marker and method of highlighting information is taught by U.S. Pat. No. 5,409,753. The publication markers taught by the '753 patent are applied to a page next to a desired segment of text, but do not extend outside of the page of text, and thus cannot therefore be seen if the page is covered by another page or any other object. If placed on the text, the colored markers obscure the text undesirably. In any case, the markers will be reproduced by a copy machine, which is also undesirable in many instances.

The currently existing flags and methods of use are not sufficient for marking and organizing large quantities of diverse information in a precise, logical and professional manner.

### SUMMARY

The present invention provides improved flags better suited for pinpointing information for a reader. Information pointed out using the improved flags is accessed more readily and various different topics and sub-topics can be very quickly accessed.

One aspect of the present invention is a sheet for temporarily marking a portion of a document, the sheet formed of a polymeric material and having a top side, an underside, a first end portion, and a second end portion. The sheet comprises a pressure sensitive repositionable adhesive on the underside of the sheet at the first end for adhering the first end portion of the sheet to a front face of the document, wherein the first end portion is preferably sufficiently transparent to allow reading of the document through the first end portion of the sheet. The sheet also comprises a colored coating, on at least a portion of the second end portion, the colored coating providing a first categorical indication, and a symbol, on the second end portion, the symbol providing a second categorical indication, the first and second categorical indications uniquely identifying the sheet.

The sheets can be packaged in dispensers, where each dispenser has a group of sheets of the same symbol and color. Alternatively, the sheets can be packaged in dispensers, where each dispenser has a group of sheets of the same color but the flags have logical sequences of characters (a type of symbol), each sheet with a different group or groups of one or more characters.

### BRIEF DESCRIPTION OF THE DRAWINGS

FIG. 1 is perspective illustration of a document flag 100.

FIGS. 2A-2C are plan views of document flag 100 with two indicative characteristics.

FIGS. 3A-3D are plan views of a document flag with three indicative characteristics.

FIG. 4 illustrates a plan view of a document flag with four indicative characteristics.

FIG. 5 illustrates electronic flags 200 in an electronic document being reviewed.

FIG. 6 illustrates an index or key of the flags.

### DETAILED DESCRIPTION OF THE PREFERRED EMBODIMENTS

The present invention includes a new type of document flag better suited for categorizing and quickly accessing relevant information, as well as methods and systems of indicating and categorizing relevant information.

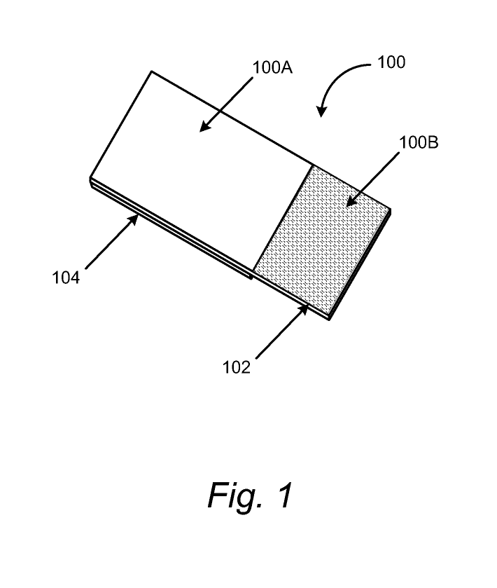

FIG. 1 shows an embodiment of a flag 100 for use in quickly locating relevant information. Flag 100 has a polymeric layer 102 with a fixed portion or end 100A and a free portion or end 100B. The fixed portion 100A is referred to as fixed, because it is meant to be affixed to a document with adhesive 104 located on the underside of fixed portion 100A. The adhesive is such that the flag can be easily affixed, removed, and otherwise repositioned as desired. The fixed portion 100A, including adhesive 104 beneath layer 102, is preferably transparent so that the contents of the underlying document can easily be read, and so that if the document is copied with the flag on it that the flag will not be reproduced in the copy. In other embodiments, the fixed portion may be colored the same or differently than the free portion or end 100B.

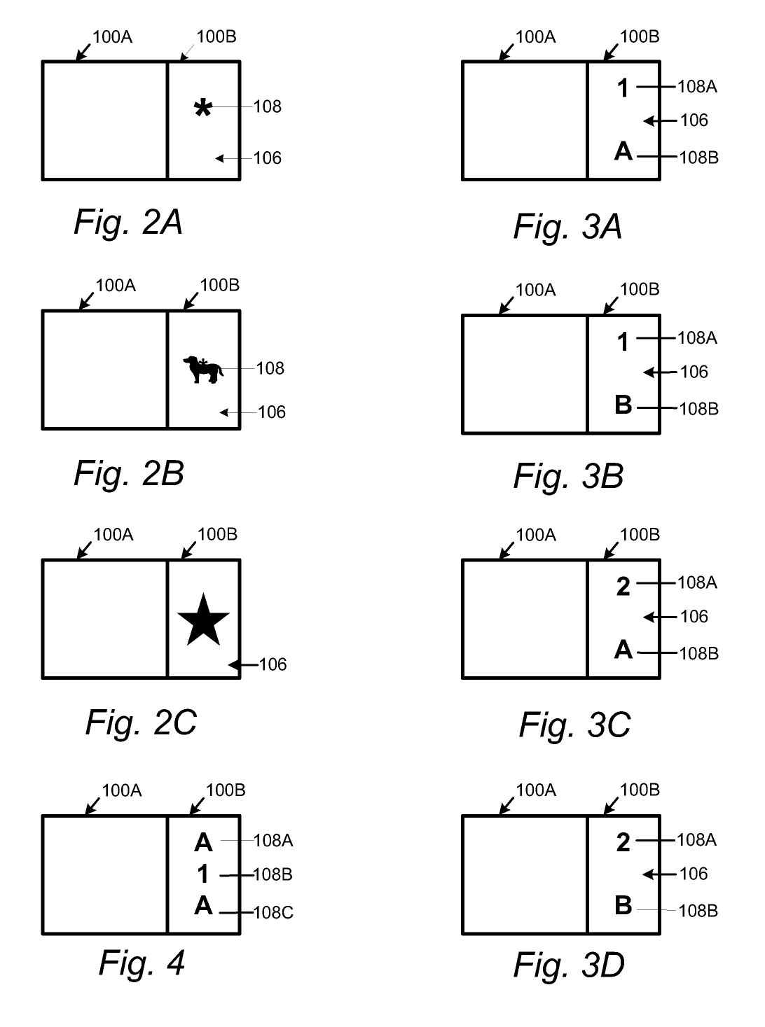

The free portion, unlike currently available flags, has 2 or more characteristics that can be used to correlate the flag with something noteworthy within a document. It is preferred, but not necessary, that a primary characteristic of the free end 100B, and thus the flag 100 is colored, because color is very quickly perceived by a reader of the document. The color may be solid or may alternatively be provided within a type of repetitive pattern, such as cross hatching or dots etc. Because color cannot be reproduced in patent figures, the color is represented in the figures as cross-hatching. Additional characteristics of the flags will be described below with regard to FIGS. 2-4. As will be described in more detail later, a particular combination of characteristics of a flag can serve as a categorical indicator in an organizational system of the present invention.

As seen in FIG. 2A, a symbol 108 is present on the free end 100B. The symbol serves as a second identifying characteristic of the flag. The first identifying characteristic is the color 106. The symbol can be any type of recognizable or distinguishable symbol, such as geometric shapes, or everyday objects. The symbol may also comprise any type of alphabetic or numeric character. Different flags such as these could be easily distinguished from each other, and examples would be “green: symbol 1” or “yellow: symbol 2” or red: symbol 3.” These flags could be easily distinguished from each other, and examples are shown in FIGS. 2A-C. In embodiments having alphabetic or numeric characters, a series of flags would preferably follow their respective logical sequences, e.g. 1, 2, 3 . . . and a, b, c . . . .

FIGS. 3A-3D depicts a flag 100 with three distinguishing characteristics or indicators, color and two symbol fields 108A and 108B. Each field can comprise one or more symbols. FIG. 4 shows a flag 100 with four distinguishing characteristics or indicators: color and three symbol fields 108A, 108B, and 108C. The number of indicators and fields are limitless, however, for rapid recognition and differentiation it is preferred that flags have not more than three or four distinguishing characteristics or indicators, as seen in the table below. This should provide sufficient differentiation between the different flags without creating difficulty in quickly arriving at the desired flag and relevant portion of the document.

TABLE 1

| Indicator 1 | Indicator 2 | Indicator 3 | Indicator x |
|---|---|---|---|
| Color | Field 1 | Field 2 | Field x |

### Topical Organization

As discussed above, the present invention provides for flags with that can be quickly and easily differentiated from each other. An organizational and/or indexing system utilizing these flags will now be described using an example application. It should be understood, however, that the system can be used to organize any subject matter desired, and that the example given should in no way limit the present invention.

One context where identifying and indexing noteworthy topics and related material within large quantities of diverse information is particularly useful is in the financial and legal arenas. In particular, voluminous amounts of financial documents relevant to damages determination in patent infringement cases need to be sorted, and essential information within the documents needs to be quickly accessed in an organized fashion by topic or degree of relevance and/or importance.

In damages determination, documents produced by the parties-in-suit are analyzed by counsel for information that is useful in the determination. Examples of such useful information include financial statements, pricing analyses, license agreements etc.

Before reviewing any documents on a given matter in depth, the key damages themes in the particular case are identified and noted. A style of flag is assigned to a theme. Preferably a color is assigned to each theme, although some other indicator could be used. For example, green flags are assigned to documents containing financial statements, orange flags are assigned to documents related to pricing or price competition, and red flags are assigned to documents related to licensing (or license agreements). The relevant categories and key damages themes are then communicated to those that will conduct the document review so that all members of the legal team use the same color system, and the appropriate flags are placed next to the relevant information. While utilizing color as a first level of indication is useful, color alone is insufficient for notation of material in complex scenarios.

Traditional colored document flags, such as Post-it® style document flags by 3M, lack the granularity required to effectively organize and sort documents. This problem is compounded by the fact that the usefulness of traditional Post-it® Style Document Flags is the lowest when the need to effectively organize and sort documents is greatest—in complex scenarios such as cases with voluminous damages-related document productions.

For example, it is not unusual for a patent infringement matter to have 30 banker-boxes (90,000 pages) or more of documents. The damages arguments in a typical case are rather complex and nuanced, and review and organization of such documents needs to accommodate the complexity of the arguments, and the categories and sub-categories of themes, topics, and information upon which the arguments rely. There are simply not enough unique flags available (in the prior art) to assign each relevant theme its own unique flag. Rather than simply placing green flags on financial documents, it would be advantageous to be able to sub-categorize financial documents into the following categories, for example:

1. Profit Forecast for Product X;

2. Profit Forecast for Product Y;

3. Historical Profit for Product X;

4. Historical Forecast for Product Y;

5. Plaintiff Historical Segment Company P&L;

6. Defendant Historical Segment Company P&L; and

7. Ad-Hoc Scenario Analyses.

Such granularity would allow one to quickly locate documents relevant to a specific topic area. Such granularity would also allow one to flag different pages of a large document, such as a strategic business plan, so that one could locate different types of financial information quickly within that large document. Accordingly, the range of unique flags according to the present invention can be used to indicate different categories, sub-categories, levels, types and importance etc. of information. Although, as mentioned earlier, any type and combination of symbols may be used to create unique flags and sets of flags, in this example it is preferable to utilize flags that incorporate logical sequences such as numbers or letters.

The following table is an example of how the flags may be used to denote particular categories and sub-categories of information. In order to aid the reader in quickly accessing desired information, an index having the same information as the table may be created and provided along with the flagged documents.

TABLE 2

| | Color | | |
|---|---|---|---|
| | (first categorical | | |
| Category or Sub-Category | indication) | Field 1 | Field 2 |
| Profit forecast for product X | Green | 1 | |
| (generally) | | | |
| Profit forecast product Y | Green | 2 | |
| (generally) | | | |
| Profit forecast for product X - | Green | 1 | A |
| period one of analysis | | | |
| Profit forecast for product X - | Green | 2 | B |
| period two of analysis | | | |
| Historical profit for product X | Yellow | 1 | |
| Historical forecast for product Y | Red | 2 | |
| Party 1 Historical Company P&L | Blue | 1 | |
| Party 2 Historical Company P&L | Blue | 2 | |

Such an improvement would greatly enhance the usability of document flags in the organization and review of documents.

Another embodiment of the invention involves placing “electronic flags” within (any type of) an electronic document that is being reviewed or otherwise organized by topic, subject matter, or level of importance etc. Due to the volume of material that needs to be reviewed and organized, often times documents are scanned in and reviewed in electronic format. This greatly increases the ease and speed of review and organization. The result of the scan is typically an image format such as a TIF, GIF, JPEG, bitmap, PDF or other type of image file. Additionally, documents can be used in their original format, or directly converted into other electronic formats that cannot be easily altered, without any intervening paper version and the associated scanning.

In such a case, while reviewing a document a user can place an electronic flag at a noteworthy part of a document with a mouse, cursor, or other human interface device of a computer. The electronic flag would comprise metadata that would not be seen in the document, and the metadata, as in the tangible flag, would comprise indicators of the noteworthy information. The metadata may also comprise a descriptor of the topic/information, which the user could type in while pacing the flag or at anytime thereafter. The electronic flags could be rendered or could be hidden, as a user selectable option. This functionality could be provided by a plug-in or applet, or could alternatively be integrated into the main software application used to view or create the image files or documents. For example, the functionality could be integrated into a word processing program or document viewing program or any program capable of viewing images or their underlying source. In another example, the functionality would be integrated into a program specifically tailored to document review. The system is also capable of creating an index of the electronic flags and their position within the document. The index would be an explanatory table or list of the symbols appearing within the document, similar to the legend of a map or chart. This would be accomplished by noting the position and contents of the relevant metadata of the electronic flags within the document.

The system has the ability to change what indicia are associated with what topic at any time. For example, on a first pass a user may flag all things potentially of interest, and later go through and assign them to a category or sub category. The hierarchical level of the topic/sub topic within the index may also be changed at any time. In another example, once things are flagged, the indicia (and corresponding topic/sub topic) may be changed or reassigned. In either case, the index in one embodiment would update automatically to reflect the current location and indicia of the flags. In another embodiment, the user selects when to update the index or table of contents at an appropriate time during the review process. If an image within a document is flagged, the index may also display a small thumbnail of the image within the index or table of contents.

The index/table may show the location of the flags/topics within several documents that are the subject of review. Documents may be added or removed from the group of documents that are subject to the same/similar review criteria and from the index/table. The position of flags can be shown in the various files, by filename and/or location in computer storage (drive)over groups of files. The “bates number” or document production number can also be displayed within the index/table. In an embodiment where multiple documents are indexed, the some or all of the flagging information may be saved in a separate file rather than as metadata within each of the separate documents/files being reviewed. For example, the flagging information for each of the flags may be saved as metadata within the documents (or copies thereof) while the index and the data used to create the index is contained in a separate file.

Additionally, during document review, the chronology of events may also be of interest. The date of the flagged material or document can also be displayed within the index table. This may in certain embodiments be displayed and organized in a separate column of the index/table. A chronological timetable may also be built from the flags. In such a case the development of products, projects, sales, or other activities can be tracked and associated with various themes of the review.

The display of the flags may be turned on or off, such that the flags may be hidden, i.e. appear solely as metadata, or the flags may be turned on and the metadata used to create the visual representation of the flag. Additionally, various types of flags may be hidden while others are displayed. For example, one or more of a first, second, or third etc. sub level/category may be chosen for display, while other levels are hidden. Likewise, only certain topics/categories may be displayed while others are hidden. In the case of multi document groups, different groups/categories of flags may be selected as hidden or displayed for different documents. All or a selected number of those documents having relevant information can then be retrieved and printed. For example, documents having information pertaining to a profit margin for a specific product for a specific period could be printed. Also either the entire document, only the flagged pages could be selected for printing. As another example, a user could select a number of pages before and after a flagged area to be retrieved and/or printed.

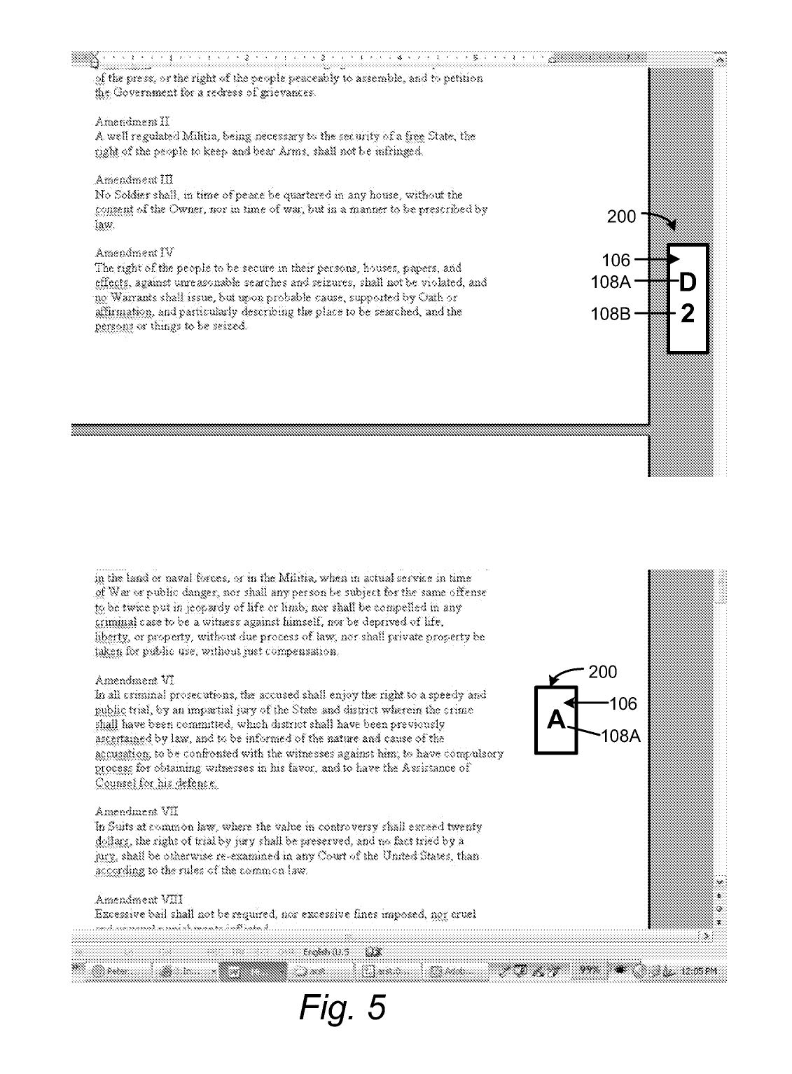

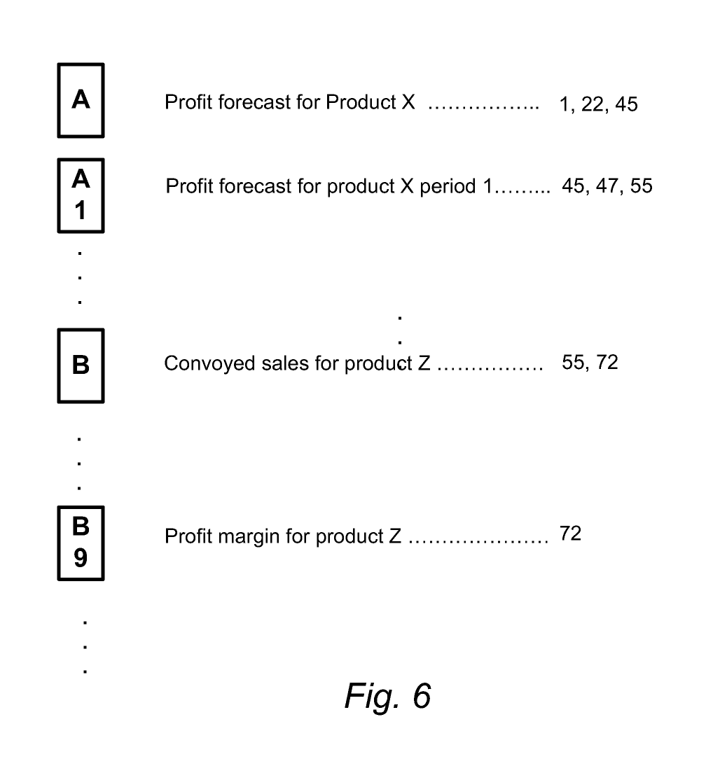

FIG. 5 shows a document with an embodiment of the electronic flags, in a state where the flags are rendered or viewable, as opposed to hidden. Note that electronic flags 200 may be rendered outside of the page or within the borders of the page. The flags are illustrated as rectangular, but may have any shape. Similar to the tangible flags 100, the electronic flag has a color 106 and one or more other indicators/characteristics 108A . . . x. When the cursor is placed over the flags, in certain embodiments, text associated with the flags, such as the category or subject matter associated with the flag, would be displayed. FIG. 6 shows an embodiment of an index of the flags. The reviewed document (whatever electronic format it may be in) could then be saved as another document or version of the document. Alternatively, the reviewed document need not be saved as a new document, given that the flags and index can be hidden by the user as desired. The metadata of the electronic flags may also be visible to a document or file management system, or search engine. Therefore, once flags are placed in the document, the system or search engine can organize groups of documents by the subject matter corresponding to the flags or indicia of the flags.

Another way the improved flags could be used is to rank the documents of a particular theme in order of their usefulness (“As” “Bs” and “Cs”). Indeed, certain financial forecasts could be more relevant than others.

Yet another way the improved flags could be used by counsel is to separate facts that may be positive or negative depending on the context of the particular situation. In a legal analysis different sets of flags may be used to indicate and differentiate “corroborating facts” from “countervailing facts.” For example, one set of market share forecasts may indicate that demand existed for a particular product, and another set of market share forecasts may indicate that demand did not exist for that same product. Before choosing which market share forecast to rely upon (and whether or not demand existed for that product), it would be helpful for counsel to be able to organize all like documents together so that a proper assessment may be made. For instance flags of a different color but the same field values, e.g. flag “green:A:2” could be used to highlight a piece of information that corroborates a particular set of assumptions whereas flag “blue:A:2” could be used to highlight a piece of information that countervails such assumptions.

Finally, the improved flag system could be used to communicate priority to a third party. For example, documents can be organized in order of priority for review by another, e.g. a client or counsel in the legal context. Such documents are preferably accompanied by a written outline, index or table of contents. The incorporation of a logical sequence on the flags would enhance the ability to link the written outline with relevant documents sections. In addition to providing greater organizational ability, logically sequenced flags of like color on work product appear more professional and polished than a rainbow smattering of colored flags on the same work product.

Logically marked colored flags could be sold individually, or in sequence. For example, Green Flags bearing the mark “1” could be sold together in one package. Alternatively, flags bearing the logical marks could be sold sequentially. For example Green flags in order “1”, “2”, “3”, or “A”, “B”, “C”, etc. would be in the same package.

Traditionally, relevant sections of a given document are highlighted based on the positioning of the document flags. For example, “Sign Here” or Arrow flags are used to identify particular sections of a subject document. However, traditional document flags may cause jams in copy machines, and accordingly such flags are typically removed before the documents are reproduced. Third-party copy vendors generally refer to this practice as “flag and replace” meaning that the flags are physically removed before copying, and then replaced after copying.

There are a few problems with the “flag and replace” system. Copy jobs that require “flag and replace” take a longer time (and typically cost more) than a similar job without flags. Perhaps more importantly, when the flags are removed, they are often not placed back in the same physical place on the original document, and the usefulness of the flag is lost or diminished.

One way of overcoming this problem is with an embodiment where the flag has adhesive on a portion of the back side of free end 100B of the flag, such that it could be folded over the edge of the original document and stuck to the back side of the document before copying, thereby eliminating the need to “flag and replace” while mitigating the risk of copy machine jamming. The fold would in certain embodiments be facilitated with a perforation at the demarcation between the free portion 100B and the fixed portion 100A. Preferably, the adhesive will either cover only some portion of the free edge 100B so that it will not inadvertently adhere to other sheets of paper or objects, or the adhesive will be covered by a flap or additional piece of material that is removed or unfolded before the free end 100B is adhered to the back side of the document.

Another way to ensure that the flag is replaced in the same place it was before removal is to incorporate a perforated edge on the flag itself Perforated edge 110 would be at the dividing line between the fixed portion 100A and the free portion 100B, as seen in FIG. 1. Before copying, the colored portion of the document flags would be removed, leaving only the transparent portion of the same flag on the page to be copied. After copying, the transparent portion of the flag would then indicate the exact spot where the replacement flag should be placed.

In order to incorporate both the perforated flag with logically sequenced flags, in certain embodiments the transparent or fixed portion 100A of the flag bears the same character of the logical sequence as the free end 100B, in an ink that would be imperceptible to a copier, yet visible to the human eye. As an example, certain types of yellow highlighters have the same property.

While the present invention was described in regard to its preferred embodiments and by using illustrative examples, and applications, it should be understood that they should not limit the scope, which is defined by the appended claims. For example, the organizational schemes, flags, and distinctive indicia can vary widely to accommodate the variance in the underlying information to be “flagged” and organized.

It is claimed:

1. A method of organizing material by topic for quick reference, the method comprising:
displaying a document to a user;
accepting flagging information from the user for one or more flags to denote one or more points of interest within the document, the flagging information comprising:
a location of a flag;
one or more identifying characteristics that uniquely identify the flag or a series of flags;
a topic
embedding metadata of the flagging information into the document; and
creating a graphical representation of the flag at or near the specified location, the flag based upon the metadata.

2. The method of claim 1, further comprising;
accepting topic information for a selected flag type, and correlating each instance of the selected flag type with the topic information.

3. The method of claim 2, further comprising:
creating a list of each unique flag type, the list comprising:
the one or more identifying characteristics of the flag type;
the topic associated with each flag type;
the location of each flag type.

4. The method of claim 2, wherein the list is organized by topics and sub topics.

5. The method of claim 3, wherein the graphical representation associated with each of the identifying characteristics is reproduced in the list.

6. The method of claim 4, wherein creating the graphical representation further comprises creating a colored flag with one or more additional indicia of the topic.

7. The method of claim 5, wherein one of the one or more additional indicia comprises at least one number.

8. The method of claim 1, wherein the graphical representation can be either displayed or hidden, as desired by a user.

9. The method of claim 1, wherein the graphical representation is created within the margins of the document.

10. A computer implemented system for organizing material, comprising:
a group of one or more electronic files having material to be viewed on a computer;
instructions executed by the computer operable to allow a user of the computer to display the material within the files and indicate selected material from within the document as being of interest, and to
flag the selected material with a flag indicative of a topic of the selected material; and
create an index of all instances of the selected material and associated flags in the one or more files.

11. The computer implemented system of claim 10, wherein the system is further operable to create a flag indicative of sub topics within the topic of the selected material, and to allow the user to flag selected material by topic and by one or more levels of hierarchical sub topics.

12. The system of claim 11, wherein the index created by the system shows the location of the topics and one or more levels of hierarchical sub topics within the files by page number within the one or more files.

13. The system of claim 11, wherein the index created by the system shows the location of the topics and one or more levels of hierarchical sub topics within the files by page number within the one or more files, and by location of the file within the computer and any storage devices networked to and/or accessed by the computer.

14. The system of claim 10, wherein the system is operable to display the flags when prompted by the user, and to alternately hide the flags when prompted by the user.

15. The system of claim 10, wherein the system is operable to jump between flags indicative of a selected topic and subtopic.

16. The system of claim 10, wherein the system is operable to allow the user to assign the association between a particular flag and its associated topic and/or sub topic.

17. The system of claim 16, wherein the system is operable to allow the user to change the association between associated flags and topics and/or sub topics after the index has been created.

18. The system of claim 10, wherein the system is operable to update the index in real time as flags and the associated topics or sub topics are added.

19. A method of organizing material by topic for quick reference, the method comprising:
displaying one or more documents to a user;
accepting flagging information from the user for one or more flags to denote one or more points of interest within the one or more documents; and
creating an index of the one or more flagged points of interest, the index comprising an entry for all or a subset of flagged points of interest.

20. The method of claim 19, further comprising presenting a list of all flagged points of interest to the user, and allowing the user to assign a hierarchical level to one or more of the flagged points of interest, the index comprising multiple hierarchical levels.

21. The method of claim 19, wherein the index contains an indication of the date or timeframe associated with one or more of the flagged points of interest.

22. The method of claim 21, wherein at least a portion of the index and a subset of the points of interest are grouped by timeframe.

23. The method of claim 22, wherein the portion of the index and subset of the points grouped by timeframe are arranged in chronological order.

24. The method of claim 19, further comprising saving data pertinent to the flags at or near the points of interest within the one or more documents.

25. The method of claim 19, further comprising saving data pertinent to the flags in a file other than one of the one or more documents displayed to the user.
